(19) United States
(12) Patent Application Publication
(10) Pub. No.: US 2021/0198822 A1
(43) Pub. Date: Jul. 1, 2021

(54) SOUND ABSORPTION AND INSULATION PAD FOR VEHICLE AND MANUFACTURING METHOD THEREOF

(71) Applicants: Hyundai Motor Company, Seoul (KR); Kia Motors Corporation, Seoul (KR); SAM WON CO., LTD, Gyeongju (KR); Toray Advanced Materials Korea Inc., Gumi (KR)

(72) Inventors: Ji Wan Kim, Hwaseong (KR); Keun Young Kim, Suwon (KR); Jung Wook Lee, Bucheon (KR); Tae Yoon Kim, Daejeon (KR); Seong Je Kim, Seongnam (KR); Yong Gu Jo, Seoul (KR); Hwang Ki Kim, Gyeongju (KR)

(21) Appl. No.: 16/883,521

(22) Filed: May 26, 2020

(30) Foreign Application Priority Data
Dec. 31, 2019 (KR) 10-2019-0178869

(51) Int. Cl. D04H 3/011; D01F 8/14; D04H 5/06; D01G 9/00; B60R 13/08

(52) U.S. Cl. CPC D04H 3/011; D01F 8/14; D04H 5/06; D10B 2505/12; B60R 13/0815; D10B 2331/04; D01G 9/00

(57) ABSTRACT

Disclosed are, inter alia, a sound absorption and insulation material including a polyester hollow fiber, a polyester low-melting-point composite fiber and a polyester base fiber, a sound absorption and insulation pad for a floor including the same, and a manufacturing method thereof for improving the elasticity and sound absorption and insulation performance of the sound absorption and insulation material. The sound absorption and insulation material is an environmentally friendly material that can reduce discomfort due to the generation of volatile organic compounds (VOCs) and the emission of toxic gases during combustion. Also, the sound absorption and insulation pad including the sound absorption and insulation material can exhibit superior sound absorption performance, sound insulation performance and actual vehicle performance compared to a conventional sound absorption and insulation pad of the same thickness.

### CROSS REFERENCE TO RELATED APPLICATION

The present application claims priority based on Korean Patent Application No. 10-2019-0178869, filed on Dec. 31, 2019, the entire content of which is incorporated herein for all purposes by this reference.

### TECHNICAL FIELD

The present invention relates to a sound absorption and insulation material including a polyester hollow fiber, a polyester low-melting-point composite fiber and a polyester base fiber, a sound absorption and insulation pad for a floor including the same, and a manufacturing method thereof.

### BACKGROUND

In general, floor pads for vehicles may have problems in that external noise generated during driving is introduced into the inside of the vehicle through various paths; in particular, noise from friction between the tire and the ground, noise from the flue gas flow at high temperature and high pressure in the exhaust system, and mechanical noise from driving the engine enter the vehicle interior, which disturbs quietness.

Conventionally, in order to improve the quietness of the passenger compartment, methods of blocking the introduction of noise into vehicles by installing sound absorption and insulation pads made of various materials on the passenger compartment floor have been used.

For example, the sound absorption and insulation pad is made of a carpet fabric and a sound absorption material, and the sound absorption material mainly includes a non-woven fabric or polyurethane foam using glass fiber, urethane foam, mixed-yarn felt, general polyester fiber, and the like.

The polyurethane foam has the advantages of easy shaping and superior compressive load compared to non-woven fabric materials, but is disadvantageous because it is impossible to recycle and has low air permeability and in that volatile organic compounds (VOCs) are generated from isocyanate additives.

Therefore, there is a need to develop a sound absorption and insulation pad capable of reducing the generation of volatile organic compounds (VOCs) and odors due thereto and improving sound absorption performance and sound insulation performance.

### SUMMARY

In preferred aspects, provided are a sound absorption and insulation material capable of reducing discomfort due to the generation of volatile organic compounds (VOCs) and exhibiting superior sound absorption performance, sound insulation performance and actual vehicle performance, and a sound absorption and insulation pad including the same.

In further preferred aspects, provided is a method of manufacturing a sound absorption and insulation material, for example, by orienting a fiber included in the sound absorption and insulation material in a direction perpendicular to a planar direction thereof, thereby exhibiting elasticity and improved sound absorption and insulation performance.

The objectives of the present invention are not limited to the foregoing, and will be able to be clearly understood through the following description and to be realized by the means described in the claims and combinations thereof.

In an aspect, provided is a sound absorption and insulation material, including a hollow fiber, a low-melting-point composite fiber, and a base fiber.

The term “hollow fiber” as used herein refers to a fiber that may have a structure that has an inner empty space, such as channel or hole, surrounded by a fiber material or other components such as filler surrounding the inner space. Preferred hollow fiber may include a core as a form of hole or channel without a filler material or other components.

The term “low-melting point composite fiber” as used herein refers to a fiber formed of at least two or more of the fiber components, which may constitute structural or physical distinction in one composite structure. Preferred low-melting point composite fiber includes at least one “low-melting point fiber” component that has a low-melting point or low-melting temperature compared to a melting temperature of a regular type fiber, for example, due to modification in chemical properties or composition of that fiber. For example, the low-melting point polyester may have a melting temperature lower, by about 10° C., 20° C., 30° C., 40° C., 50° C., 60° C., 70° C., 80° C., 90° C., 100° C., 150° C., 200° C., 250° C., 300° C., or more, than that of the regular polyester.

The sound absorption and insulation material may suitably include an amount of about 10 to 50 wt % of the hollow fiber, an amount of about 20 to 40 wt % of the low-melting-point composite fiber, and an amount of about 20 to 50 wt % of the base fiber. All the wt % are based on the total weight of the sound absorption and insulation material.

The hollow fiber may suitably have a fineness of about 5 to 15 denier, a fiber length of about 50 to 70 mm, a hollow core ratio of about 25 to 29%, a bulkiness of about 12,300 to 12,800 cm³/g and about 4 to 10 crimps/inch.

The low-melting-point composite fiber may suitably have a fineness of about 3 to 5 denier, a fiber length of about 40 to 60 mm and a melting point of about 100 to 200° C.

The base fiber may suitably have a fineness of about 5 to 15 denier and a fiber length of about 50 to 70 mm.

The hollow fiber or the base fiber may suitably include a polyester fiber.

The low-melting-point composite fiber may suitably include a low-melting-point polyester fiber as a sheath and a regular polyester fiber as a core.

The polyester fiber may suitably include one or more selected from the group consisting of polyethylene terephthalate (PET), polybutylene terephthalate (PBT), and polytrimethylene terephthalate (PTT).

The hollow fiber, the low-melting-point composite fiber or the base fiber may be arranged perpendicular to a planar direction of the sound absorption and insulation material.

The sound absorption and insulation material may suitably have a noise reduction coefficient (NRC) of about 0.799 to 0.830, a sound insulation coefficient of about 18 to 22%, and a power-based noise reduction (PBNR) of about 43 to 44 dB.

In an aspect, provided is a sound absorption and insulation pad including the sound absorption and insulation material as described herein.

The sound absorption and insulation pad may suitably have a noise reduction coefficient (NRC) of about 0.950 to 1.100.

In an aspect, provided is a method of manufacturing a sound absorption and insulation material. The method may include steps of: manufacturing a mixed fiber by mixing a hollow fiber, a low-melting-point composite fiber and a base fiber, scutching the mixed fiber using a scutching machine, carding the scutched mixed fiber, for example, using a carding machine, orienting the carded mixed fiber in a direction perpendicular to a planar direction, and thermally treating the perpendicularly oriented mixed fiber.

The carding machine may be maintained at a feed rate of about 160 to 180 RPM (Revolutions Per Minute) and a doffer of about 740 to 760 RPM.

The thermally treating the mixed fiber may be performed in a hot-air oven at a temperature of about 140 to 160° C.

The sound absorption and insulation material is an environmentally friendly material that can reduce discomfort due to the generation of volatile organic compounds (VOCs) and the emission of toxic gases during combustion.

In addition, the sound absorption and insulation pad can exhibit superior sound absorption performance, sound insulation performance and actual vehicle performance compared to a conventional sound absorption and insulation pad of the same thickness.

The method of manufacturing the sound absorption and insulation material can improve the elasticity and sound absorption and insulation performance of the sound absorption and insulation material.

Vehicles that comprise a sound absorption and insulation material or a sound and absorption pad as disclosed herein also are provided.

Other aspects of the invention are disclosed infra.

The effects of the present invention are not limited to the foregoing, and should be understood to include all effects that can be reasonably anticipated from the following description.

### BRIEF DESCRIPTION OF DRAWINGS

FIG. 1 is a flowchart showing an exemplary process of manufacturing a sound absorption and insulation material according to an exemplary embodiment of the present invention;

FIG. 2 shows an exemplary operation of blades for orienting a mixed fiber in a direction perpendicular to a planar direction according to an exemplary embodiment of the present invention;

FIG. 3 is a graph showing the sound absorption coefficient at 400 to 10,000 Hz in Comparative Example 1-1, Comparative Example 1-2 and Example 1-1 according to an exemplary embodiment of the present invention;

FIG. 4 is a graph showing the sound absorption coefficient at 400 to 10,000 Hz in Example 1-1 to Example 1-3 according to an exemplary embodiment of the present invention;

FIG. 5 is a graph showing the sound insulation coefficient at 100 to 10,000 Hz in Comparative Example 2 and Example 2 according to an exemplary embodiment of the present invention;

FIG. 6 is a graph showing PBNR (dB) at 400 to 8,000 Hz in Comparative Example 2 and Example 2 according to an exemplary embodiment of the present invention;

FIG. 7 is a graph showing the sound absorption coefficient at 400 to 10,000 Hz in Comparative Example 3 and Example 3 according to an exemplary embodiment of the present invention; and

FIG. 8 shows an exemplary sound absorption and insulation material manufactured according to an exemplary embodiment of the present invention, in which a hollow fiber, a low-melting-point composite fiber and a base fiber are arranged in a direction perpendicular to a planar direction of the sound absorption and insulation material.

### DETAILED DESCRIPTION

The above and other objectives, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the invention and to sufficiently transfer the spirit of the present invention to those skilled in the art.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof.

Unless otherwise specified, all numbers, values, and/or representations that express the amounts of components, reaction conditions, polymer compositions, and mixtures used herein are to be taken as approximations including various uncertainties affecting measurements that essentially occur in obtaining these values, among others, and thus should be understood to be modified by the term “about” in all cases.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum). In an aspect, provided is a sound absorption and insulation material that may include a hollow fiber, a low-melting-point composite fiber and a base fiber, and is preferably formed by mixing a hollow fiber, a low-melting-point composite fiber and a base fiber and performing thermal bonding.

The sound absorption and insulation material according to an exemplary embodiment of the present invention may suitably include an amount of about 10 to 50 wt % of the hollow fiber, an amount of about 20 to 40 wt % of the low-melting-point composite fiber and an amount of about 20 to 50 wt % of the base fiber.

The amount of each component of the sound absorption and insulation material according to the present invention, which will be described below, is represented based on 100 wt % (total weight) of the sound absorption and insulation material. If the amount basis thereof is changed, the new basis will always be set forth, so that a person skilled in the art will clearly know the basis on which the amount is described.

(1) Hollow Fiber

The hollow fiber is not particularly limited, so long as it imparts bulkiness and elasticity to the sound absorption and insulation material. The hollow fiber may include a polyester fiber, a polyurethane fiber, a vinyl ester fiber or an epoxy fiber, and may preferably be a polyester fiber capable of reducing discomfort due to the generation of volatile organic compounds (VOCs) and the emission of toxic gases during combustion and exhibiting superior sound absorption and insulation performance.

The polyester fiber used as the hollow fiber may include one or more selected from the group consisting of polyethylene terephthalate (PET), polybutylene terephthalate (PBT), and polytrimethylene terephthalate (PTT). The hollow fiber may preferably be PET.

The amount of the hollow fiber may suitably be an amount of about 10 to 50 wt % based on the total weight of the sound absorption and insulation material. When the amount thereof is less than about 10 wt %, sound absorption performance may decrease. On the other hand, when the amount thereof is greater than about 50 wt %, workability may decrease due to bulkiness and poor product formability may result.

The spun hollow fiber may have a fineness of about 5 to 15 denier, a fiber length of about 50 to 70 mm, a hollow core ratio of about 25 to 29%, bulkiness of about 12,300 to 12,800 cm³/g and about 4 to 10 crimps/inch. When the fineness thereof is less than about 5 denier, the strength of the nonwoven fabric may decrease, and the weight of the nonwoven fabric may increase due to the excessive density of the nonwoven fabric. On the other hand, when the fineness thereof is greater than about 15 denier, the density of the nonwoven fabric may decrease due to the excessive bulkiness thereof, and the sound absorption coefficient may decrease. Also, when the fiber length is less than about 50 mm, the surface may not be sufficiently smooth due to fluffing or peeling upon processing of the nonwoven fabric. On the other hand, when the fiber length is greater than about 70 mm, poor workability for nonwoven fabrics may result. Also, when the hollow core ratio is less than about 25%, poor sound absorption performance may result. On the other hand, when the hollow core ratio is greater than about 29%, the density or workability of the nonwoven fabric may decrease due to the high bulkiness thereof. Also, when the bulkiness is less than about 12,300 cm³/g, the elasticity and bulkiness of the nonwoven fabric may decrease and thus sound absorption performance may decrease. On the other hand, when the bulkiness is greater than about 12,800 cm³/g, it is difficult to mount parts due to the high thickness of the nonwoven fabric. Also, when the number of crimps is less than about 4/inch, it is difficult to perform a carding process. On the other hand, when the number of crimps is greater than about 10/inch, poor carding processability may result due to the high crimp density.

(2) Low-Melting-Point Composite Fiber

The low-melting-point composite fiber is not particularly limited, so long as it is able to bind the hollow fiber and the base fiber, which are mixed, to each other upon thermal treatment. The low-melting-point composite fiber may include a regular fiber or a low-melting-point fiber, and may preferably include a fiber formed by subjecting a regular fiber and a low-melting-point fiber to composite spinning. The regular fiber or low-melting-point fiber may be a polyester fiber, a polyurethane fiber, a vinyl ester fiber or an epoxy fiber. Preferably, the regular fiber or low-melting-point fiber may a regular polyester fiber or a low-melting-point polyester fiber, which may reduce discomfort due to the generation of volatile organic compounds (VOCs) and the emission of toxic gases during combustion, and may exhibit superior sound absorption and insulation performance.

The polyester fiber usable as the regular fiber and the low-melting-point fiber included in the low-melting-point composite fiber may include one or more selected from the group consisting of polyethylene terephthalate (PET), polybutylene terephthalate (PBT), polytrimethylene terephthalate (PTT). The polyester fiber usable as the regular fiber and the low-melting-point fiber included in the low-melting-point composite fiber may preferably be PET.

The low-melting-point composite fiber may preferably include a low-melting-point polyester fiber as a sheath and a regular polyester fiber as a core. For example, the regular polyester fiber as the core may include PET, and the low-melting-point polyester fiber as the sheath may be prepared by mixing 100 parts by weight of terephthalic acid (TPA), about 47 to 75 parts by weight of isophthalic acid (IPA), about 67 to 74 parts by weight of ethylene glycol (EG), and about 2.5 to 13 parts by weight of diethylene glycol (DEG).

The amount of the low-melting-point composite fiber may preferably be an amount of about 20 to 40 wt % based on the total weight of the sound absorption and insulation material. When the amount thereof is less than about 20 wt %, it may be difficult to bind the hollow fiber and the base fiber, which are mixed, to each other. On the other hand, when the amount thereof is greater than about 40 wt %, the resulting sound absorption material may become hard.

The spun low-melting-point composite fiber may have a fineness of about 3 to 5 denier, a fiber length of about 40 to 60 mm and a melting point of about 100 to 200° C. When the fineness thereof is less than about 3 denier, it is difficult to bind the fiber due to insufficient adhesion. On the other hand, when the fineness thereof is greater than about 5 denier, the resulting nonwoven fabric may become hard due to excessive adhesion. Also, when the fiber length is less than about 40 mm, there is a high possibility that the surface may not sufficiently smooth due to fluffing or peeling upon processing of nonwoven fabrics. On the other hand, when the fiber length is greater than about 60 mm, uniform fiber distribution may not be sufficient, and thus the strength of the nonwoven fabric is lowered. Also, when the melting point is lower than about 100° C., a vehicle may be easily deformed due to low external heat when parked outside, which may cause the shape of the nonwoven fabric to change. On the other hand, when the melting point is greater than about 200° C., binder fusion may become impossible in a typical hot-air oven due to the high melting point.

(3) Base Fiber

The base fiber, which is a substrate for a sound absorption and insulation material, is not particularly limited so long as it is a recycled environmentally friendly substrate that is able to exhibit improved sound absorption and insulation performance. The base fiber may suitably include a polyester fiber, a polyurethane fiber, a vinyl ester fiber or an epoxy fiber. The base fiber may preferably be a short fiber having a solid cross-section, as a polyester fiber, which may reduce discomfort due to the generation of VOCs and the emission of toxic gases during combustion, may exhibit superior sound absorption and insulation performance, and may be recycled.

The polyester fiber usable as the base fiber may include one or more selected from the group consisting of polyethylene terephthalate (PET), polybutylene terephthalate (PBT), and polytrimethylene terephthalate (PTT), or particularly, PET.

The content base fiber may be in an amount of about 20 to 50 wt % based on the total weight of 100 wt % of the sound absorption and insulation material. When the amount thereof is less than about 20 wt %, the function thereof as a substrate may deteriorate. On the other hand, when the amount thereof is greater than about 50 wt %, sound absorption and insulation performance may decrease.

The spun base fiber may suitably have a fineness of about 5 to 15 denier and a fiber length of about 50 to 70 mm, or particularly, about 51 to 64 mm. When the fineness thereof is less than about 5 denier, it is difficult to maintain the shape of the nonwoven fabric with the base fiber. On the other hand, when the fineness thereof is greater than about 15 denier, the elasticity of vertical nonwoven fabrics may decrease and low density may result. Also, when the fiber length is less than about 50 mm, a short fiber serving as the base fiber may not be randomly distributed. On the other hand, when the fiber length is greater than about 70 mm, a short fiber serving as the base fiber may agglomerate.

(4) Sound Absorption and Insulation Material and Sound Absorption and Insulation Pad

The sound absorption and insulation material may be formed by mixing the hollow fiber, the low-melting-point composite fiber and the base fiber and then performing thermal bonding. The sound absorption and insulation material may have a noise reduction coefficient (NRC) of about 0.799 to 0.830, a sound insulation coefficient of about 18 to 22%, and a power-based noise reduction (PBNR) of about 43 to 44 dB. Thus, the noise reduction coefficient (NRC) and the sound insulation coefficient are high compared to conventional sound absorption and insulation materials, and the power-based noise reduction (PBNR) is higher by 1 dB or more.

In addition, the sound absorption and insulation pad may include the sound absorption and insulation material described above, for example, the pad may include a floor material and a sound absorption and insulation material. The floor material may be a nonwoven fabric carpet or a bulked continuous filament (BCF) loop pile carpet. For example, as the floor material, a BCF material may be suitably because a single thread is connected through an entirety thereof and no fine hairs fall out. The sound absorption and insulation pad may have a noise reduction coefficient (NRC) of about 0.950 to 1.100.

The sound absorption and insulation pad including the sound absorption and insulation material may exhibit superior sound absorption performance, sound insulation performance and actual vehicle performance.

Moreover, in an aspect, the sound absorption and insulation material may be manufactured using an environmentally friendly polyester fiber, and thus may reduce discomfort due to the generation of VOCs and the emission of toxic gases during combustion. The hollow fiber, the low-melting-point composite fiber or the base fiber, which is included through mixing in the sound absorption and insulation material of the present invention, may be arranged perpendicular to a planar direction of the sound absorption and insulation material as shown in FIG. 8 through the method described herein. As such, the elasticity and sound absorption and insulation performance of the sound absorption and insulation pad including the same may be further improved.

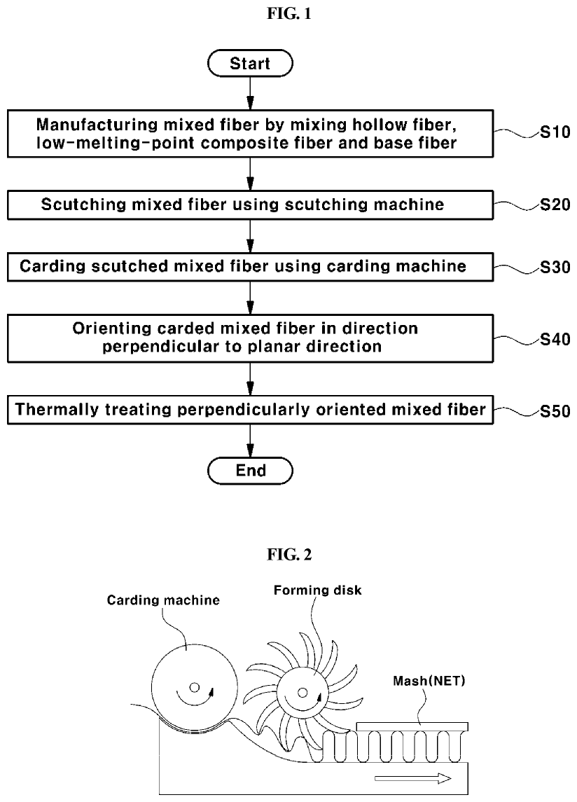

FIG. 1 is a flowchart showing an exemplary process of manufacturing the sound absorption and insulation material according to an exemplary embodiment of the present invention. With reference thereto, the method includes manufacturing a mixed fiber by mixing a hollow fiber, a low-melting-point composite fiber and a base fiber (S10), scutching the mixed fiber using a scutching machine (S20), carding the scutched mixed fiber using a carding machine (S30), orienting the carded mixed fiber in a direction perpendicular to a planar direction (S40), and thermally treating the perpendicularly oriented mixed fiber (S50).

During the step of manufacturing the mixed fiber (S10), the mixed fiber may be manufactured by mixing the hollow fiber, the low-melting-point composite fiber and the base fiber.

For example, the hollow fiber and the base fiber may be prepared by spinning a polyester resin using a spinning machine, and the low-melting-point composite fiber may be prepared by subjecting a regular polyester resin and a low-melting-point polyester resin to composite spinning using a spinneret typically used in the art.

The hollow fiber, the low-melting-point composite fiber and the base fiber, prepared above, may be placed in a mixing tank in amounts of about 10 to 50 wt %, about 20 to 40 wt % and about 20 to 50 wt %, respectively, and are uniformly mixed, and thus the resulting mixed fiber is stored.

During the step of the scutching using the scutching machine (S20), the mixed fiber thus prepared may be opened and stretched. For example, the mixed fiber may be supplied to the scutching machine from the mixing tank and may then be scutched. When the mixed fiber is transferred toward a feed roller via a conveyor, the mixed fiber may be grasped by the feed roller and scutched by a cylinder, whereby the mixed fiber supplied above may be provided in the form of uniformly mixed cotton.

During the step of carding using the carding machine (S30), the scutched mixed fiber may be uniformly stretched, for example, the scutched mixed fiber may be supplied to the carding machine, and based on the same principle as combing, fiber strands are separated one by one and completely opened, such that the fiber may be stretched so as to have a web structure (web: thin-film fiber structure). Meanwhile, stretching thereof may vary depending on the RPM (Revolutions Per Minute) of the feed and the doffer of the carding machine so it may be appropriately adjusted depending on the thickness and properties of the sound absorption and insulation material to be configured (as desired by a consumer).

The carding machine may be maintained at a feed rate of about 160 to 180 RPM and a doffer of about 740 to 760 RPM. When the feed rate is less than about 160 RPM, productivity may decrease. On the other hand, when the feed rate is greater than about 180 RPM, production becomes difficult due to the high weight. Also, when the doffer is less than about 740 RPM, productivity may decrease. On the other hand, when the doffer is greater than about 760 RPM, high-weight shaping becomes difficult.

Orienting the mixed fiber perpendicular to the planar direction (S40) is a step of forming the fiber to a required thickness by orienting the fiber in a direction perpendicular to the planar direction while folding the fiber using blades. As shown in FIG. 2, while the mixed fiber supplied from the carding machine may be folded using a plurality of blades disposed on the outer surface of a forming disk, the mixed fiber may be oriented perpendicular to the planar direction, which is the blade movement direction, such that the mixed fiber may be formed to a desired thickness, as shown in FIG. 8.

The sound absorption and insulation pad including the sound absorption and insulation material that may be finally manufactured as described herein and may be further improved in view of elasticity and sound absorption and insulation performance.

During the step of the thermal treatment (S50), the perpendicularly oriented mixed fiber may be thermally treated and thus formed in a manner in which the low-melting-point composite fiber is melted by heat and thus bonded, followed by cooling, thereby maintaining the sound absorption and insulation material in the form of having a necessary thickness. For example, the fiber, perpendicularly oriented and having a predetermined thickness, may be placed in an oven, and may be heated through a zone having a necessary height (thickness). The mixed fiber may be shaped while the low-melting-point fiber is melted by heat, and may be continuously cooled by being passed through a cooling machine, thereby manufacturing a sound absorption and insulation material.

The oven is configured such that a hot press is provided so as to maintain a predetermined gap, which is wider than the thickness (height) of the formed fiber passing therethrough, in a hot-air oven for generating heat, and heat at a temperature of about 140 to 160° C. may be applied (which may vary depending on the thickness). When the temperature is lower than about 140° C., the stiffness of the nonwoven fabric, may be reduced. On the other hand, when the temperature is higher than about 160° C., a risk of a fire may exist. The cooling machine is configured to include a cooling press in which a hot-air fan heater is disposed at a predetermined interval so as to pass cooling water or cooling oil therethrough or such that the fiber passed through the oven is cooled using cold air, such that the mixed fiber passed through the oven and the cooling machine is formed into the sound absorption and insulation material.

After the thermal treatment and cooling steps, cutting the manufactured sound absorption and insulation material may be further performed. For example, the sound absorption and insulation material thus manufactured may include edge portions having non-uniform thicknesses at both sides thereof, the edge portions of the sound absorption and insulation material may be trimmed, and the sound absorption and insulation material may be cut to a size desired by a user.

Moreover, the step of manufacturing the sound absorption and insulation pad may include a step of integrally bonding a floor material to the manufactured sound absorption and insulation material, and for example, the low-melting-point fiber may be melted and thus the regular fiber may be bonded.

### EXAMPLE

A better understanding of the present invention will be given through the following examples. These examples are merely set forth to illustrate the present invention but are not to be construed as limiting the scope of the present invention.

### Example 1-1

(S10) 30 g of a hollow fiber as a high-elasticity fiber including a polyester resin, particularly a PET resin, and having a fineness of 7 denier, and 40 g of a base fiber comprising a regular environmentally friendly fiber and having a fineness of 7 denier were spun and prepared. Also, a low-melting-point composite fiber was prepared in a manner in which 30 g of a regular polyester resin, particularly a PET resin, and having a fineness of 4 denier, and 40 g of a low-melting-point polyester resin obtained by mixing 100 parts by weight of terephthalic acid (TPA), 47 to 75 parts by weight of isophthalic acid (WA), 67 to 74 parts by weight of ethylene glycol (EG), and 2.5 to 13 parts by weight of diethylene glycol (DEG) were subjected to composite spinning. The hollow fiber, the low-melting-point composite fiber and the base fiber, prepared above, were mixed in amounts of 40 wt %, 30 wt % and 30 wt %, respectively, thereby preparing a mixed fiber.

(S20, S30) The mixed fiber prepared above was scutched using a scutching AR mixing machine and the mixed fiber was provided in the form of uniformly mixed cotton. The scutched mixed fiber was uniformly stretched using a roller carding machine. Here, the carding machine was operated at a feed rate of 160 to 180 RPM and a doffer of 740 to 760 RPM.

(S40) The mixed fiber supplied from the carding machine was oriented perpendicular to a planar direction, which is the blade movement direction, using blades, thereby manufacturing a mixed fiber having a thickness 20 T (20 mm).

(S50) The mixed fiber having a thickness of 20 T was placed in a hot-air oven to thus bind at 140 to 160° C., and passed through a cooling machine at 15° C., thereby manufacturing a sound absorption and insulation material having 20 T, a size of 1.2×1 M and a planar density of 1200 gsm.

### Example 1-2

A sound absorption and insulation material was manufactured in the same manner as in Example 1-1, with the exception that a hollow fiber having 15 denier and a base fiber having 15 denier were spun and mixed.

### Example 1-3

A sound absorption and insulation material was manufactured in the same manner as in Example 1-1, with the exception that a base fiber having 15 denier was spun and mixed.

### Example 2

In order to evaluate a part made of the sound absorption and insulation material manufactured above, a composite sound absorption and insulation material was manufactured by integrally laminating the sound absorption and insulation material having a thickness of 20 T, a size of 840×840 mm and a planar density of 2400 gsm, manufactured as in Example 1-1, with a fabric (nylon/polyester nonwoven fabric (N/P) and a PE coating of 250 gsm) and a sound insulation material (AP coating of 1000 gsm).

### Example 3

A sound absorption and insulation pad was manufactured in a manner in which the sound absorption and insulation material having a planar density of 2400 gsm, manufactured as in Example 1-1, was integrally laminated with a BCF loop pile carpet (9 Oz) as a floor material, a PE coating of 300 gsm and a sound insulation material (AP coating of 1000 gsm) through a T-die process followed by a hot-melt bonding process.

### Comparative Example 1-1

A urethane foam having an apparent density of 85 K was manufactured according to a conventional technique.

### Comparative Example 1-2

A sound absorption and insulation material was manufactured in the same manner as in Example 1-1, with the exception that 70% wt % of the low-melting-point composite fiber and 30 wt % of the base fiber were mixed to afford a mixed fiber.

### Comparative Example 2

In order to evaluate a part made of the urethane foam, a composite urethane foam was manufactured by integrally laminating the urethane foam having a thickness of 20 T, a size of 840×840 mm and an apparent density of 85 K, manufactured as in Comparative Example 1-1, with a nylon/polyester nonwoven fabric (N/P), a PE coating of 250 gsm and a sound insulation material (AP coating of 1000 gsm).

### Comparative Example 3

A sound absorption and insulation pad was manufactured in a manner in which the urethane foam having an apparent density of 85 K, manufactured as in Comparative Example 1-1, was integrally laminated with a BCF loop pile carpet (9 Oz) as a floor material, a PE coating of 300 gsm and a sound insulation material (AP coating of 1000 gsm) through a T-die process followed by a hot-melt bonding process.

### Test Example 1—Evaluation of Sound Absorption Performance of Sound Absorption and Insulation Material

The sound absorption coefficients of the sound absorption and insulation material manufactured in Example 1-1 according to an exemplary embodiment of the present invention and the urethane foam and the sound absorption and insulation material manufactured respectively in Comparative Example 1-1 and Comparative Example 1-2 were measured. The results thereof are shown in Table 1 below.

TABLE 1

| | | Comparative | Comparative |
|---|---|---|---|
| Frequency [Hz] | Example 1-1 | Example 1-1 | Example 1-2 |
| 400 | 0.388 | 0.243 | 0.232 |
| 500 | 0.626 | 0.478 | 0.390 |
| 630 | 0.726 | 0.658 | 0.413 |
| 800 | 0.771 | 0.872 | 0.512 |
| 1,000 | 0.851 | 0.952 | 0.601 |
| 1,250 | 0.892 | 0.899 | 0.667 |
| 1,600 | 0.875 | 0.871 | 0.697 |
| 2,000 | 0.844 | 0.832 | 0.751 |
| 2,500 | 0.830 | 0.753 | 0.774 |
| 3,150 | 0.825 | 0.728 | 0.786 |
| 4,000 | 0.817 | 0.689 | 0.790 |
| 5,000 | 0.812 | 0.704 | 0.740 |
| 6,300 | 0.874 | 0.776 | 0.710 |
| 8,000 | 0.936 | 0.760 | 0.715 |
| 10,000 | 0.953 | 0.724 | 0.797 |
| NRC | 0.801 | 0.729 | 0.638 |

* Measurement method = The sound absorption and insulation material sample and the urethane foam sample, manufactured above, were placed in a measurement chamber, 15 sound sources ranging from 400 Hz to 10,000 Hz were input, and the sound absorption coefficient of the material against reverberation was measured and compared (ISO 354)
* Noise reduction coefficient (NRC) = Average of sound absorption coefficient values ranging from 400 to 10,000 Hz

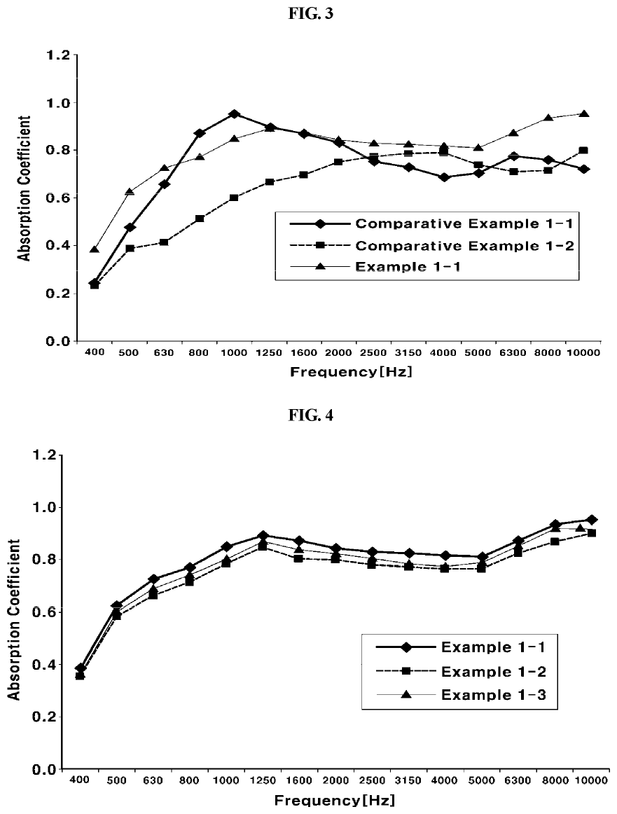

As shown in Table 1 and FIG. 3, the noise reduction coefficient was 0.801 in Example 1-1, 0.729 in Comparative Example 1-1 and 0.638 in Comparative Example 1-2, indicating that the noise reduction coefficient of Example 1-1 was greater than the noise reduction coefficient of Comparative Examples 1-1 and 1-2.

Therefore, the sound absorption and insulation material manufactured according to the exemplary embodiments of the present invention exhibited superior sound absorption performance compared to conventional urethane foam and to sound absorption and insulation materials of which the component proportions fell out of the ranges of the present invention.

### Test Example 2—Evaluation of Sound Absorption Performance Depending on Thickness of Fiber Included in Sound Absorption and Insulation Material

The sound absorption coefficients of the sound absorption and insulation materials manufactured in Example 1-1 to Example 1-3 according to the exemplary embodiments of the present invention were measured. The results thereof are shown in Table 2 below.

TABLE 2

| Frequency [Hz] | Example 1-1 | Example 1-2 | Example 1-3 |
|---|---|---|---|
| 400 | 0.38774237 | 0.3541942 | 0.36584234 |
| 500 | 0.62622943 | 0.5827366 | 0.600763661 |
| 630 | 0.7258185 | 0.6637322 | 0.689921539 |
| 800 | 0.77077543 | 0.7159251 | 0.742984783 |
| 1,000 | 0.85117879 | 0.7840002 | 0.804351783 |
| 1,250 | 0.8921578 | 0.8478025 | 0.870796837 |
| 1,600 | 0.87499796 | 0.8030664 | 0.838134217 |
| 2,000 | 0.84432079 | 0.799092 | 0.823860033 |
| 2,500 | 0.82954355 | 0.7816184 | 0.806134893 |
| 3,150 | 0.82537351 | 0.7727316 | 0.78532056 |
| 4,000 | 0.81722142 | 0.7661789 | 0.77636544 |
| 5,000 | 0.81166015 | 0.7642325 | 0.789583237 |
| 6,300 | 0.87408339 | 0.8241633 | 0.855162175 |
| 8,000 | 0.93585896 | 0.8682667 | 0.920321447 |
| 10,000 | 0.95338693 | 0.9003318 | 0.918137062 |
| NRC | 0.8013566 | 0.7485381 | 0.772512001 |

* Measurement method = The sound absorption and insulation material sample and the urethane foam sample, manufactured above, were placed in a measurement chamber, 15 sound sources ranging from 400 Hz to 10,000 Hz were input, and the sound absorption coefficient of the material against reverberation was measured and compared (ISO 354)
* Noise reduction coefficient (NRC) = Average of sound absorption coefficient values ranging from 400 to 10,000 Hz

As shown in Table 2 and FIG. 4, the noise reduction coefficient was 0.801 in Example 1-1, 0.749 in Example 1-2 and 0.773 in Example 1-3, indicating that the noise reduction coefficient of Example 1-3 was greater than that of Example 1-2 and that the noise reduction coefficient of Example 1-1 was greater than that of Example 1-3.

Therefore, it was confirmed that the sound absorption and insulation material manufactured according to exemplary embodiments of the present invention exhibited superior sound absorption performance with a decrease in the thickness of the low-melting-point composite fiber and the base fiber.

### Test Example 3—Evaluation of Sound Insulation Performance of Sound Absorption and Insulation Material

In order to evaluate the performance of a part made of the composite sound absorption and insulation material manufactured in Example 1-1 according to the exemplary embodiment of the present invention, the transmission loss of the composite sound absorption and insulation material manufactured in Example 2 and the transmission loss of the composite urethane foam manufactured in Comparative Example 2 were measured, and the sound insulation results thereof are shown in Table 3 below.

TABLE 3

| Hz | Example 2 | Comparative Example 2 |
|---|---|---|
| 100 | 2.78 | 4.50 |
| 125 | 6.39 | 4.68 |
| 160 | 1.75 | 5.15 |
| 200 | −1.53 | 0.04 |
| 250 | 3.39 | −0.68 |
| 315 | 2.48 | −4.90 |
| 400 | 4.41 | −0.46 |
| 500 | 10.11 | 2.44 |
| 630 | 16.66 | 5.42 |
| 800 | 24.44 | 8.14 |
| 1000 | 19.46 | 9.01 |
| 1250 | 21.29 | 9.91 |
| 1600 | 26.52 | 14.87 |
| 2000 | 29.62 | 15.40 |
| 2500 | 30.55 | 20.99 |
| 3150 | 35.78 | 29.23 |
| 4000 | 32.78 | 33.05 |
| 5000 | 39.59 | 42.69 |
| 6300 | 42.69 | 45.54 |
| 8000 | 41.44 | 43.14 |
| 10000 | 31.49 | 31.58 |

* Measurement method = The sound absorption and insulation material sample and the urethane foam sample, manufactured above, were placed in a measurement chamber shown in FIG. 5, and the transmission loss thereof was measured at intervals of ⅓ octave from 100 Hz to 10,000 Hz.

### Test Example 4—Evaluation of Actual Vehicle Performance of Sound Absorption and Insulation Material

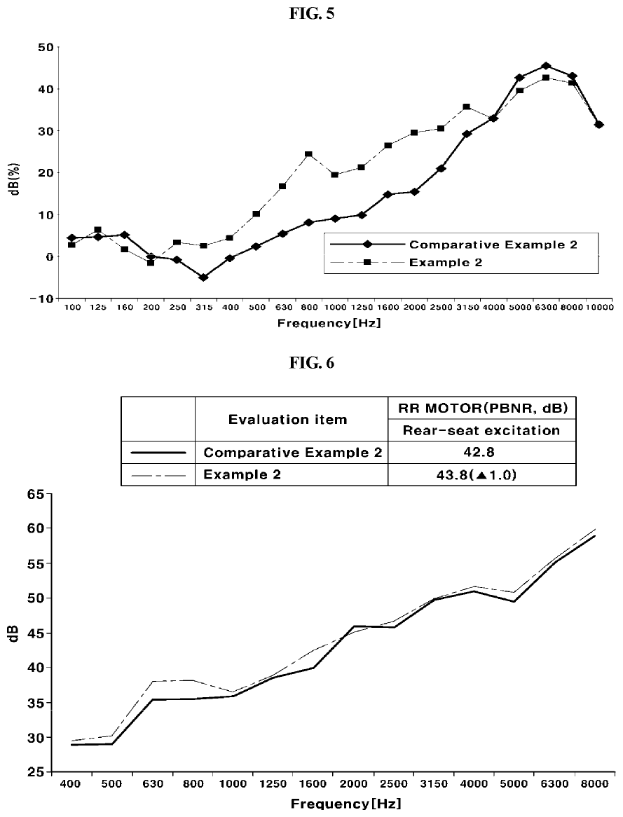

In order to evaluate the performance of a part made of the sound absorption and insulation material manufactured in Example 1-1 according to the exemplary embodiment of the present invention, the power-based noise reduction (PBNR) of the composite sound absorption and insulation material manufactured in Example 2 and the PBNR of the composite urethane foam manufactured in Comparative Example 2 were measured, and the results thereof are shown in FIG. 6.

The PBNR measurement was performed using the ATF for the sound pressure relationship of the engine room microphone and the volume acceleration of the point source. This technique is capable of quantitatively measuring the amount of noise reduction due to air transfer based on acoustic reciprocity.

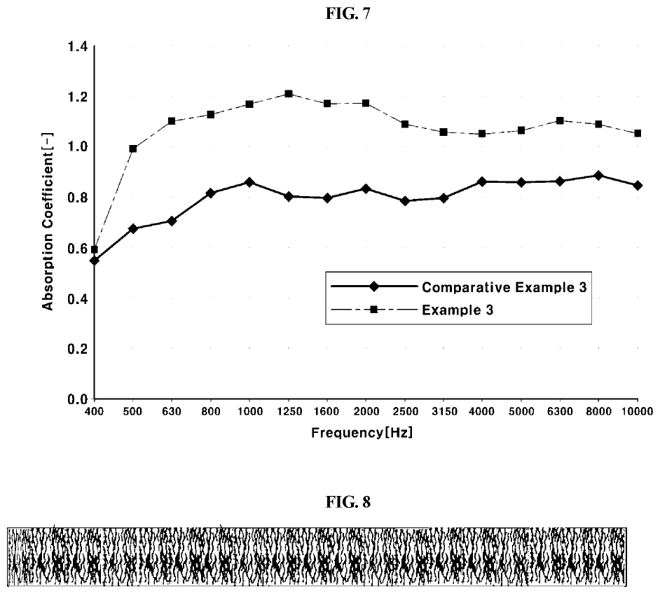

For a typical sound absorption and insulation part, the greater the weight, the better the PBNR performance. The weight of the composite sound absorption and insulation material of Example 2 was 3,380 g and the weight of the composite urethane foam of Comparative Example 2 was 4,136 g. Although the weight of the composite sound absorption and insulation material of Example 2 was reduced by 756 g, based on the results of evaluation of PBNR, as shown in FIG. 7, PBNR (dB) was about 43.8 dB in Example 2 and about 42.8 dB in Comparative Example 2, indicating that the PBNR of Example 2 was greater than that of Comparative Example 2.

Therefore, the sound absorption and insulation material manufactured according to the exemplary embodiments of the present invention exhibited superior actual vehicle performance compared to the urethane foam according to the conventional technique.

### Test Example 5—Evaluation of Sound Absorption Performance of Sound Absorption and Insulation Pad

The sound absorption coefficients of the sound absorption and insulation pad manufactured in Example 3 according to an exemplary embodiment of the present invention and the urethane foam pad manufactured in Comparative Example 3 were measured. The results thereof are shown in Table 4 below.

TABLE 4

| Frequency [Hz] | Example 3 | Comparative Example 3 |
|---|---|---|
| 400 | 0.590 | 0.549 |
| 500 | 0.993 | 0.677 |
| 630 | 1.101 | 0.706 |
| 800 | 1.126 | 0.817 |
| 1000 | 1.170 | 0.830 |
| 1250 | 1.211 | 0.804 |
| 1600 | 1.172 | 0.797 |
| 2000 | 1.172 | 0.834 |
| 2500 | 1.091 | 0.786 |
| 3150 | 1.059 | 0.798 |
| 4000 | 1.051 | 0.862 |
| 5000 | 1.065 | 0.859 |
| 6300 | 1.104 | 0.864 |
| 8000 | 1.090 | 0.886 |
| 10000 | 1.054 | 0.848 |
| NRC | 1.070 | 0.769 |

* Measurement method = The sound absorption and insulation material sample and the urethane foam sample, manufactured above, were placed in a measurement chamber, 15 sound sources ranging from 400 Hz to 10,000 Hz were input, and the sound absorption coefficient of the material against reverberation was measured and compared (ISO 354).
* Noise reduction coefficient (NRC) = Average of sound absorption coefficient values ranging from 400 to 10,000 Hz

As shown in Table 4 and FIG. 7, the noise reduction coefficient was 1.070 in Example 3 and 0.796 in Comparative Example 3, indicating that the noise reduction coefficient of Example 3 was greater than that of Comparative Example 3.

Therefore, the sound absorption and insulation pad including the sound absorption and insulation material manufactured according to various exemplary embodiments of the present invention exhibited superior sound absorption performance compared to the urethane foam pad including the urethane foam according to the conventional technique.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A sound absorption and insulation material, comprising:
a hollow fiber;
a low-melting-point composite fiber; and
a base fiber.

2. The sound absorption and insulation material of claim 1, comprising:
an amount of 10 to 50 wt % of the hollow fiber;
an amount of 20 to 40 wt % of the low-melting-point composite fiber; and
an amount of 20 to 50 wt % of the base fiber,
all wt % are based on the total weight of the sound absorption and insulation material.

3. The sound absorption and insulation material of claim 1, wherein the hollow fiber has a fineness of about 5 to 15 denier, a fiber length of 50 to 70 mm, a hollow core ratio of 25 to 29%, a bulkiness of 12,300 to 12,800 cm³/g and 4 to 10 crimps/inch.

4. The sound absorption and insulation material of claim 1, wherein the low-melting-point composite fiber has a fineness of 3 to 5 denier, a fiber length of 40 to 60 mm and a melting point of 100 to 200° C.

5. The sound absorption and insulation material of claim 1, wherein the base fiber has a fineness of 5 to 15 denier and a fiber length of 50 to 70 mm.

6. The sound absorption and insulation material of claim 1, wherein the hollow fiber or the base fiber is a polyester fiber.

7. The sound absorption and insulation material of claim 1, wherein the low-melting-point composite fiber comprises a low-melting-point polyester fiber as a sheath and a regular polyester fiber as a core.

8. The sound absorption and insulation material of claim 6, wherein the polyester fiber comprises one or more selected from the group consisting of polyethylene terephthalate (PET), polybutylene terephthalate (PBT), and polytrimethylene terephthalate (PTT).

9. The sound absorption and insulation material of claim 1, wherein the hollow fiber, the low-melting-point composite fiber or the base fiber is arranged perpendicular to a planar direction of the sound absorption and insulation material.

10. The sound absorption and insulation material of claim 1, having a noise reduction coefficient (NRC) of 0.799 to 0.830, a sound insulation coefficient of 18 to 22%, and a power-based noise reduction (PBNR) of 43 to 44 dB.

11. A sound absorption and insulation pad comprising a sound absorption and insulation material of claim 1.

12. The sound absorption and insulation pad of claim 11, having a noise reduction coefficient (NRC) of 0.950 to 1.100.

13. A vehicle comprising a sound absorption and insulation material of claim 1.

14. A vehicle comprising a sound absorption and insulation pad of claim 11.

15. A method of manufacturing a sound absorption and insulation material, comprising:
manufacturing a mixed fiber by mixing a hollow fiber, a low-melting-point composite fiber and a base fiber;
scutching the mixed fiber using a scutching machine;
carding the scutched mixed fiber using a carding machine;
orienting the carded mixed fiber in a direction perpendicular to a planar direction; and
thermally treating the perpendicularly oriented mixed fiber.

16. The method of claim 15, wherein the carding machine is maintained at a feed rate of 160 to 180 RPM (Revolutions Per Minute) and a doffer of 740 to 760 RPM.

17. The method of claim 15, wherein the thermally treating the mixed fiber is performed in a hot-air oven at a temperature of 140 to 160° C.
